(19) United States
(12) Patent Application Publication
(10) Pub. No.: US 2011/0247419 A1
(43) Pub. Date: Oct. 13, 2011

(54) TIME REVERSAL ACOUSTIC NONCONTACT SOURCE

(75) Inventors: Timothy James Ulrich, Los Alamos, NM (US); Brian Eric Anderson, Provo, UT (US); Pierre-Yves Le Bas, Los Alamos, NM (US)

(73) Assignee: Los Alamos National Security, LLC, Los Alamos, NM (US)

(21) Appl. No.: 12/757,565

(22) Filed: Apr. 9, 2010

(51) Int. Cl. G01N 29/04

(52) U.S. Cl. 73/643

(57) ABSTRACT

The present invention provides a flexible noncontact source of wave energy through the use of time reversal. In the preferred embodiment a differential laser vibrometer is employed to measure the vibration of a sample surface. Thus, the time reversal noncontact source can be configured to provide an out of plane vibration source or an in plane vibration source, or any combination of the two.

### STATEMENT REGARDING FEDERAL RIGHTS

This invention was made with government support under Contract No. DE-AC52-06NA25396, awarded by the U.S. Department of Energy. The government has certain rights in the invention.

### BACKGROUND OF INVENTION

This invention relates to a method and apparatus for providing noncontact acoustic excitation. More particularly, the present invention relates to providing a more flexible noncontact source of wave energy than is currently available. The present method and apparatus have a variety of commercial applications. Some examples of possible commercial applications include nondestructive evaluation, such as defect detection and imaging, structural health monitoring, medical ultrasound diagnostics and therapy, acoustic welding and any other application where localized noncontact acoustic excitation and/or detection is desirable.

The ability to provide noncontact acoustic excitation allows for nondestructive evaluation of materials. However, currently used traditional nondestructive evaluation techniques have severe limitations in detection of incipient fatigue damage. Due to these difficulties, considerable effort has been focused on detection of cracks that appear at very late stages of the life of the material. The amount of remaining life in a material after the formation of microcracks is quite small compared to the entire life of the material. There are a few methods that currently exist to provide noncontact acoustic excitation. These include the use of electromagnetic acoustic transducers (EMATs), laser based excitation, and focused ultrasonic transducers. Of these, only focused ultrasonic transducers (FUTs) provide even a modicum of flexibility. However FUTs are still limiting.

Some of the disadvantages of the existing methods are as follows:
1. EMATs:
   EMATs rely on the ability to use electromagnetism to induce a magnetic field on the surface of the sample to be excited. If the sample is non-magnetic, the EMAT has no effect and is therefore useless.
   EMATs are inherently nonlinear, thus the use of an EMAT for nonlinear studies is undesirable, as the nonlinearity of the EMAT can be much greater than the nonlinearity of the material being tested.
2. Laser based excitation:
   One method of acoustic excitation is through high powered pulsed lasers. The acoustic waves arise from a local heating due to the high powered laser. The pulsed nature precludes the ability to define a specific force function (e.g., an arbitrary waveform or sinusoidal signal), rather the excitation is impulsive, much like that of a hammer, and inflexible (excluding repetition rate and sometimes laser power).
   Laser ultrasonic grids have been developed to excite high frequency (20 MHz) surface waves. While this is slightly more customizable in the signal types that can be generated they are not at all suitable for complex waveforms, and the sample must be prepared precisely with a deposited film in a specific pattern that defines the signal to be excited.
3. FUTs:
   Focused transducers have a fixed focal distance.
   Focused transducers have a narrow bandwidth.
   Focused transducers are large, thus making it difficult (usually impossible) to use more than one in order to increase the low amplitude output.

Finally, all of these excitation methods suffer from low excitation amplitude. The present invention, in contrast does not have any of the above mentioned limitations, it can achieve greater amplitudes, and can be calibrated by a user. Additionally, the present invention has the ability to excite motion in different directions (e.g., in-plane and out of plane with respect to the sample surface) without the need to be reoriented, a feature that other techniques cannot do regardless of orientation.

In many nondestructive evaluation experiments it is desirable to excite a sample without contacting it. A source transducer in contact with a sample must be fastened onto the sample in some manner. Adhesive glue is generally used. Some drawbacks of a contact transducer are as follows:
If the adhesive is not strong enough the source transducer may fall off of the sample. However if the adhesive is too strong then the transducer cannot be easily removed without damaging the sample under test.
If the adhesive does not entirely cover the full surface area of the transducer then the transducer is not being fully utilized resulting in less efficiency.
If the contact adhesive is too thin, or not used at all, then the transducer vibrations may excite contact nonlinearity.

A noncontact source transducer allows one to easily and quickly move the source location to many locations on the sample surface. A contact source locally alters the acoustic nature of the sample and can affect measurements in the same manner that an accelerometer adds as extra mass to the sample it is attached to. This is the fundamental advantage of a noncontact laser vibrometer over accelerometers. Accordingly, there is still a need in the art for a non-contact technique to measure the changes in the property of a material.

### SUMMARY OF INVENTION

The present invention meets these and other needs by providing a more flexible noncontact source of wave energy than is currently available. Current commercially available noncontact transducers are designed to operate at a fixed standoff distance from the sample and are designed to operate at a narrow frequency band.

Accordingly, one aspect of the invention is the use of time reversal. Time Reversal (TR) is a method applicable to classical wave systems of physics to locate and reconstruct unknown wave sources or to locate and image target scatterers (using specific signal processing enhancement and selection methods). TR relies on the principle of spatial reciprocity, i.e. the ray paths that a wave pulse will travel from a source to a receiver will be the same ray paths that an identical wave pulse will travel if the source and receiver positions are interchanged. Dispersion, multiple scattering, mode conversion, anisotropy, refraction, and weak attenuation do not limit the ability of using TR to focus on a source. For example, multiple scattering can be exploited in order to enhance the effective aperture of a Time Reversal Mirror if the forward propagation signals are collected within appropriately long time windows thereby improving TR focusing abilities.

The use of TR to create a noncontact source allows a much greater degree of flexibility in terms of available standoff distances. The standoff distance can be set to whatever distance is desired (as long as it can still excite the surface of the sample under test) and calibrated accordingly. The TR noncontact source is more flexible in terms of the available excitation frequency content since one can achieve TR focusing with any desirable frequency content.

The present invention also utilizes a differential laser vibrometer, or an appropriate in-plane laser vibrometer, which allows the in-plane vibration of the sample's surface to be measured. Thus the TR noncontact source can be configured to provide amount of out of plane vibration source or and in plane vibration source, or any combination of the two. Currently there are no commercial solutions that can provide a noncontact in plane vibration source.

Multiple laser positions could be measured without moving the reverberant cavity to allow multiple source excitation, each with various phases. The utilization of multiple individually phased sources could allow directed source energy like an array provides.

These and other aspects, advantages, and salient features of the present invention will become apparent from the following detailed description, the accompanying drawings, and the appended claims.

### BRIEF DESCRIPTION OF THE DRAWINGS

FIG. 1 is a schematic of the present invention.

FIG. 2a shows a comparison of results achieved using the present invention and a standard focused ultrasound transducer.

FIG. 2b shows another comparison of results achieved using the present invention and a standard focused ultrasound transducer.

### DETAILED DESCRIPTION

The present invention is a novel way to excite and detect broadband acoustic signals without contact. Some benefits of the present invention over the prior art are the ability for the present invention to have broadband operation, the ability to have a variable standoff distance, the variable excitation amplitude, the possibility of user calibration, a user definable source function, the knowledge of absolute excitation function, the use for excitation and detection is possible, and greater efficiency.

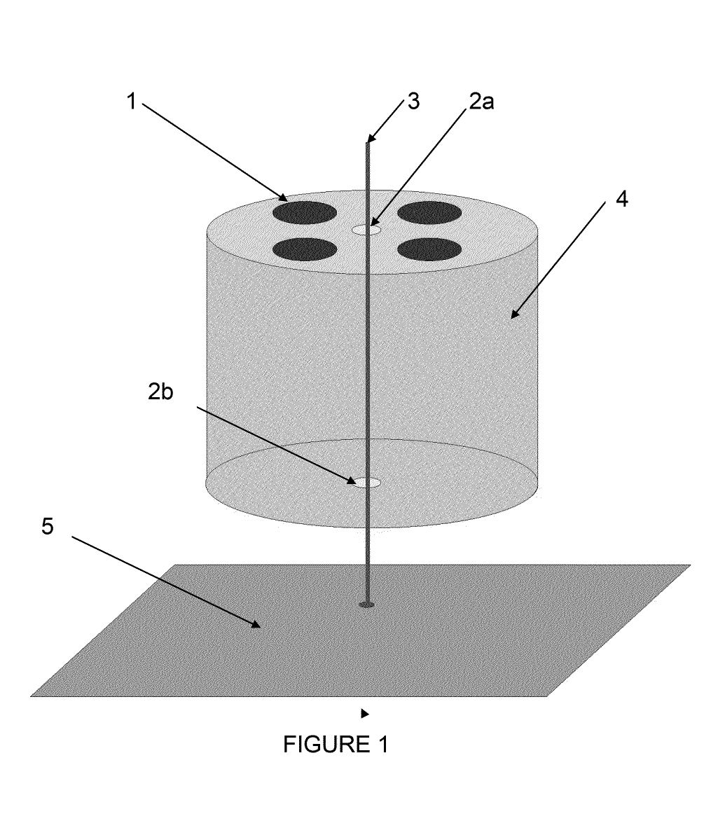

FIG. 1 shows the present invention. The TR process involves a source and one or more receivers known as the TR Mirror (TRM). TRM elements 1 may be any device that can focus waves using the time reversal method. In TR a source is emitted from location A and detected at location B. This received signal, which can be much longer in duration than the original source due to scattering, is flipped in time, amplified and broadcast into the medium. Standard TR broadcasts the time reversed signals from receiver B, thus focusing the energy upon the original source location A. Due to reciprocity, source and receiver locations can be interchanged, thus broadcasting the time reversed signal from the original source A, the focus of energy occurs at the original receiver location B. With a non-contact detector, such as laser vibrometer 3, it is then possible to focus energy wherever the detector can measure a response. This technique, known as Reciprocal TR, has been used together with nonlinear methods, in what is called the Time Reversal Elastic Nonlinearity Diagnostic (TREND) for nondestructive evaluation. Focusing energy in this manner allows one to achieve much higher amplitudes than standard methods without the need for ultra-high power amplifiers. The key to the increased amplitudes is simply a conservation of energy. The fact that all of the energy contained in the long duration scattered signal is collapsed onto the highly localized (in space and time) focal point makes the TR process extremely efficient. The amplitude also scales linearly with the number of TRM elements, thus increasing from one to N elements, increases the focal amplitude by a factor N.

The Reciprocal TR process, with a quasi-closed acoustic cavity, can be used to focus the acoustic energy traveling inside the cavity (and scattering off the walls) through a small hole to a location outside of the cavity onto the surface of a nearby sample. In the embodiment shown in FIG. 1, a small cylindrical can 4, having a volume of approximately 0.5 L and made of metal, with a four element (i.e., channel) TRM 1 is used. It is noted that a variety of quasi-closed acoustic cavities may be suitable for use in the present invention. Can 4 has a pair of pass through holes 2a and 2b for the laser vibrometer 3 to measure the signals to be time reversed and broadcast from the four elements of the TRM 1.

Hole 2a is the aperture and hole 2b is the orifice from which scattered waves escape the cavity to focus on the surface. In all other respects, can 4 is sealed to maximize the amount of internal scattering of acoustic waves, and thus fully utilize the ability of TR to use the scattered energy and focus it upon the surface of the sample surface 7.

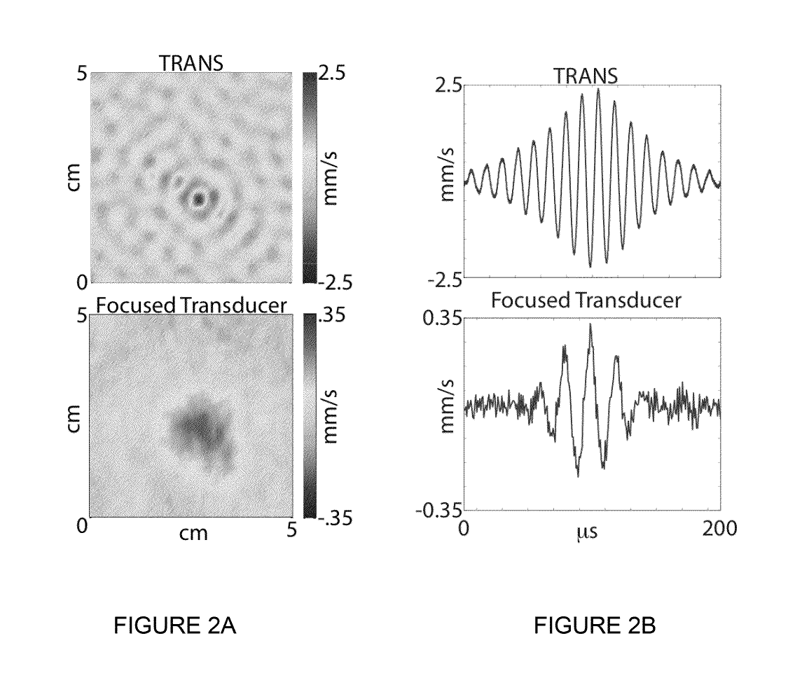

As shown in FIGS. 2a and 2b, a comparison was done between similarly sized focused ultrasound transducer and the present invention. In both cases the same sample and surface was scanned. FIG. 2a shows the spatial extent of the excitation region. As can be seen, the present invention has a much smaller focal spot (red areas of the excitation region images). FIG. 2b shows the temporal signal at the point of focus (i.e., maximum amplitude location in spatial extent images). FIG. 2b demonstrates the increased signal quality and amplitude of the present invention. The present invention achieves amplitude that is nearly an order of magnitude greater than that of the prior art. Additionally, the signal is much clearer.

In use, the present invention may be set up at virtually any standoff distance as desired and then maybe calibrated accordingly. Additionally the present invention may be easily and quickly moved to many locations on the sample surface. This affords the present invention a great deal of flexibility. As the present invention is completely customizable, and the TR processes is valid in both reception and transmission, the present invention can be used as either a source of excitation or as a receiver. When paired with a noncontact detector (e.g., a laser vibrometer), the present invention can be used to simultaneously excite and detect at the same location.

Referring to the drawings in general, it will be understood that the illustrations are for the purpose of describing a particular embodiment of the invention and are not intended to limit the invention thereto.

What is claimed is:

1. A method of noncontact excitation of a sample, comprising the steps of:
using the process of time reversal to create a noncontact source of wave energy;
and customizing the source in order to allow for greater flexibility.

2. A method in accordance with claim 1, comprising the further step of utilizing a laser vibrometer to detect vibration at the same point in time and space.

3. A method in accordance with claim 1, wherein a variety of signals may be utilized.

4. A method in accordance with claim 1, comprising the further step of exciting a particular area.

5. A method in accordance with claim 4, wherein the shape of the excitation area may be customized.

6. A method in accordance with claim 1, comprising the further step of detecting the vibration of a sample.

7. A system for creating a non-contact source of energy, the system comprising:
a noncontact vibration sensor;
a transducer; and
an acoustic cavity.

8. A system in accordance with claim 7 wherein the noncontact vibration sensor is a laser vibrometer.

9. A system in accordance with claim 7, wherein the transducer is an acoustic transducer.

10. A system in accordance with claim 7, wherein the transducer is an ultrasonic transducer.

11. A system in accordance with claim 7, wherein the acoustic cavity is closed except for an exit hole and an optical port.

12. A system in accordance with claim 7, wherein the system may be used as a source, as a receiver, or may be used as both a source and receiver.
